(19) United States
(12) Patent Application Publication
(10) Pub. No.: US 2004/0147276 A1
(43) Pub. Date: Jul. 29, 2004

(54) Reduced signaling power headroom feedback

(76) Inventors: Ralph Gholmieh, San Diego, CA (US); Rath Vannithamby, San Diego, CA (US); Thawatt Gopal, San Diego, CA (US)

Correspondence Address: COATS & BENNETT, PLLC, P O BOX 5, RALEIGH, NC, 27602, US

(21) Appl. No.: 10/736,815

(22) Filed: Dec. 16, 2003

Related U.S. Application Data
(60) Provisional application No. 60/433,937, filed on Dec. 17, 2002.

(51) Int. Cl. H04B 7/185; H04Q 7/20

(52) U.S. Cl. 455/522; 455/9; 370/318

(57) ABSTRACT

A radio base station (RBS) reduces the signaling overhead associated with maintaining rapidly updated estimates of transmit power headroom for a plurality of mobile stations. According to an exemplary embodiment, the RBS receives relatively infrequently periodic full reports from each mobile station that include an indication of the current transmit power headroom of the mobile station. The RBS then tracks the changes in the mobile station's headroom over the intervals between full reports based on reverse link power control information associated with the mobile station. The RBS adjusts the stored headroom value based on the reverse link power control commands sent by it, or based on power control decision feedback from the mobile station. In either case, use of the power control information keeps the stored headroom value accurate even over relatively long full reporting intervals.

### RELATED APPLICATIONS

This application claims priority under 35 U.S.C. § 119(e) from the following U.S. provisional application: Application Serial No. 60/433,937 filed on Dec. 17, 2002. That application is incorporated in its entirety by reference herein.

### BACKGROUND OF THE INVENTION

The present invention generally relates to wireless communication networks, and particularly relates to tracking mobile station power headroom.

In many types of wireless communication networks, and particularly in Code Division Multiple Access (CDMA) networks, the reverse radio link from mobile stations to the network, e.g., to a given radio base station represents a “managed” resource. For example, because the number of mobile stations simultaneously transmitting on the reverse link affects total interference at the base station, use of the reverse link may be “scheduled.”

Several scheduling approaches are used in existing networks, or are planned for various next-generation wireless networks. In general, however, reverse link scheduling involves designating which one or ones in a set of mobile stations can use the reverse link at what times and at what data rates. For example, with Dedicated Rate Control (DRC), the base station grants specific mobile stations permission to transmit at particular rates at particular times. By changing such permissions over time, the base station can schedule users to achieve a desired reverse link “fairness” objective, to achieve a “maximum throughput” objective, or to achieve some other service objective.

In another approach to rate control, the base station broadcasts Common Rate Control (CRC) commands that indicate whether the mobile stations should increase, decrease, or hold their current reverse link transmission rates. Thus, if reverse link loading, i.e., noise plus interference, was relatively high at the base station, it might transmit one or a series of down commands. Conversely, it might transmit one or a series of up commands if the reverse link load was relatively light.

Generally, knowledge of certain mobile station conditions improves the base station's ability to carry on user scheduling in an efficient manner. For example, knowing the power headroom of each mobile station subject to scheduling provides a basis for determining whether a particular mobile station does or does not have the ability to operate at a contemplated higher rate. For example, the base station's reverse link scheduler might, for each scheduling interval, select a subset of mobile stations to operate at higher reverse link data rates and, in that context, it would not select any mobile station that lacked sufficient power headroom to operate at a higher rate.

### SUMMARY OF THE INVENTION

The present invention comprises a method and apparatus for tracking mobile station transmit power headroom at a wireless communication network base station based on periodically receiving full power headroom reports from the mobile stations and, in the intervals between the full reports, using reverse link transmit power control information to track power headroom changes. Use of the reverse link power control information allows the base station to keep its estimated headroom values relatively accurate over several or many transmit frame times, and thus the frequency of full power headroom reporting can be reduced, thereby reducing the signaling overhead attendant with transmitting power headroom information from the mobile stations to the network.

Thus, in an exemplary embodiment of the present invention, an exemplary method of tracking mobile station power headroom at a wireless communication network base station comprises receiving a power headroom report from a mobile station, storing a headroom value for the mobile station based on the power headroom report received from the mobile station, and updating the headroom value to track changes in a transmit power of the mobile station based on reverse link power control information associated with the mobile station. Such processing at the base station may comprise periodically receiving a full report from a mobile station that indicates a transmit power headroom of the mobile station, updating a headroom value maintained at the base station for the mobile station responsive to receiving each full report, and tracking changes in transmit power headroom between each full report using reverse link power control information associated with the mobile station.

In one embodiment, the reverse link power control information comprises the reverse link power control commands being transmitted from the base station to the mobile station as part of ongoing operations. Thus, the headroom value tracks changing power conditions at the mobile station by decrementing it each time the base station transmits an up command to the mobile station, and by incrementing it each time the base station transmits a down command to the mobile station. In an alternative embodiment, the base station maintains the headroom value during the intervals between full reports based on receiving one or more differential reports from the mobile station. These differential reports indicate the power control adjustments being made at the mobile station as part of its ongoing reverse link power control.

Knowledge of each mobile station's current transmit power headroom may be used in a number of ways by the base station and by the network at large, and the present invention is not limited to a specific use of such information. However, in an exemplary embodiment of the present invention, the base station uses its knowledge of mobile station transmit power headroom to avoid attempts to increase the reverse link rate of mobile stations that lack sufficient power headroom to operate at higher rates. For example, in reverse link scheduling or Dedicated Rate Control (DRC) procedures, the base station would avoid picking mobile stations for rate increases if they lacked sufficient power headroom.

According to an exemplary embodiment of the present invention, a base station for use in a wireless communication network comprises transceiver circuits to communicate with a plurality of mobile stations via wireless signaling, and one or more processing circuits to control communications with the plurality of mobile stations. The one or more processing circuits include a headroom tracking circuit configured to track transmit power headroom for each mobile station by periodically receiving a full report from the mobile station that indicates a transmit power headroom of the mobile station, updating a headroom value maintained at the base station for the mobile station responsive to receiving each full report, and tracking changes in transmit power headroom between each full report using reverse link power control information associated with the mobile station.

The present invention is not limited by these exemplary embodiments. Those skilled in the art will recognize additional features and advantages upon reading the following detailed description, and upon viewing the accompanying drawings.

### BRIEF DESCRIPTION OF THE DRAWINGS

FIG. 1 is a diagram of a wireless communication network according to one or more exemplary embodiments of the present invention.

FIG. 2 is a diagram of typical variations in a mobile station's transmit power and headroom over several reverse link transmit frames.

FIG. 3 is a diagram of exemplary transmit power headroom tracking according to one embodiment of the present invention.

FIGS. 4A and 4B are exemplary diagrams for power headroom tracking based on transmitted power control commands.

FIGS. 5A and 5B are exemplary diagrams for power headroom tracking based on power control decision feedback.

FIG. 6 is a diagram of an exemplary mobile station and radio base station configured to support the present invention.

### DETAILED DESCRIPTION OF THE INVENTION

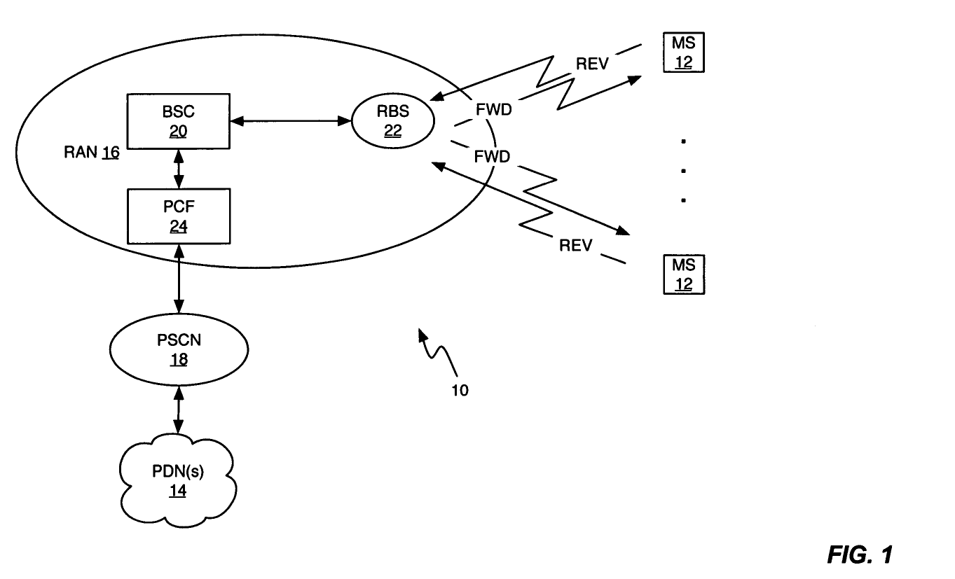

FIG. 1 is a diagram of an exemplary wireless communication network 10 according to one or more embodiments of the present invention. Network 10 may be a cdma2000 network configured according to IS-2000 standards but the present invention is applicable to networks configured according to other standards, such as Wideband CDMA (WCDMA). Regardless, as illustrated, network 10 communicatively couples a plurality of mobile stations 12 to one or more Public Data Networks (PDNs) 14, such as the Internet.

Network 10 comprises a Radio Access Network (RAN) 16 that is coupled to the PDN(s) 14 through a Packet Switched Core Network (PSCN) 18. RAN 16 comprises at least one Base Station (BS) that includes a Base Station Controller 20 and one or more associated Radio Base Stations (RBSs) 22. BSC 20 may include packet control interface circuits to communicate with PSCN 18, or may couple to PSCN 18 through a Packet Control Function 24. While only one BSC 20 and RBS 22 are illustrated for clarity, it should be understood that RAN 16 may include a plurality of BSCs 20, each controlling one or more RBSs 22. Further, network 10 may include additional entities not illustrated, such as a Circuit Switched Core Network (CSCN) to communicatively couple RAN 16 to the Public Switched Telephone Network (PSTN).

RBS 22 transmits signals to mobile stations 12 on one or more forward link channels, and receives signals from them on one or more reverse link channels. In an exemplary embodiment, RBS 22 provides closed-loop reverse link power control wherein it controls the transmit power of each mobile station 12 to receive the mobile station's transmissions at a targeted received signal quality. For example, according to IS-2000 standards, RBS 22 transmits power control commands to each mobile station 12 at a defined power control rate, e.g., 400 Hz, 800 Hz, etc. Each power control command transmitted to a given mobile station 12 tells the mobile station 12 to increment (up command) or decrement (down command) its reverse link transmit power. Thus, by streaming the appropriate mix of up and down commands to each mobile station 12 at the defined power control rate, the RBS 22 maintains each mobile stations' reverse link power at the appropriate level.

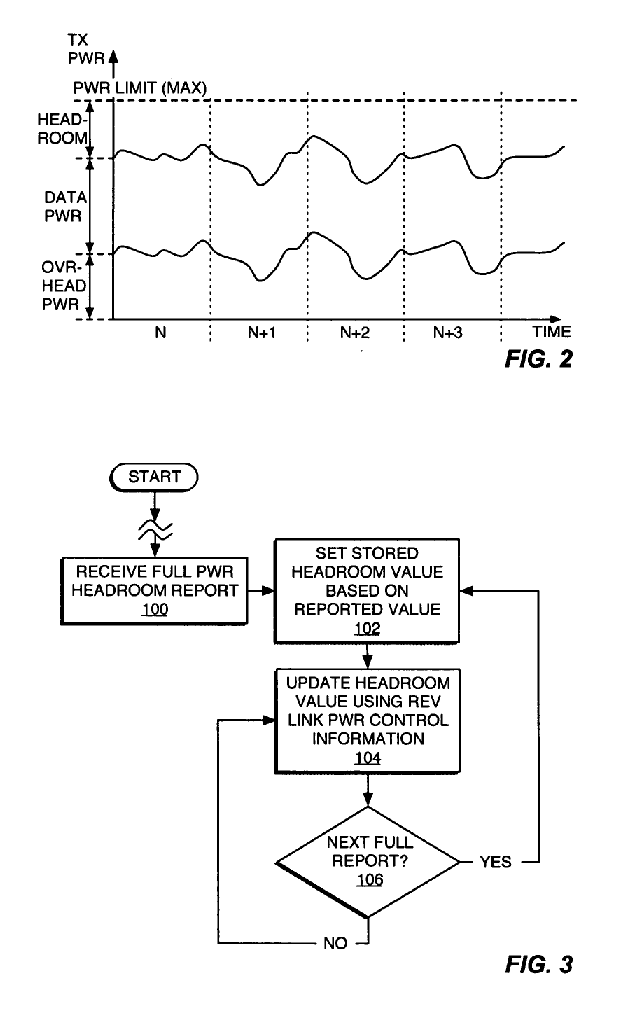

FIG. 2 illustrates the reverse link power control process for a given mobile station 12 over several reverse link transmit frames, shown as N, N+1, and so on. The mobile station's transmit power varies up and down over time responsive to incoming reverse link power commands received from RBS 22 and, possibly, from other RBSs 22, such as when mobile station 12 is in soft handoff. In an exemplary embodiment, the reverse link transmit frames are 10 ms, and the mobile station 12 receives eight power control commands per frame, i.e., it receives a PCB every 1.25 ms.

The mobile station's total reverse link transmit power includes the power allocated to its pilot signal transmissions, control channel signals, etc., which collectively is referred to as “overhead” power. An additional amount of the mobile station's transmit power is allocated to transmitting data as needed or desired on, for example, a reverse link packet data channel. The remaining unused transmit power may be considered “power headroom,” as it represents the amount by which the mobile station 12 could increase its transmit power if commanded by RBS 22. Note that FIG. 2 illustrates a constant data power proportionality over time for simplicity, but that proportionality might vary, such as where varying data rates are used.

As will be explained later herein, knowledge of each mobile station's transmit power headroom provides the RBS 22 with the ability to make reverse link rate control decisions, make scheduling decisions, etc. The present invention provides a method and apparatus whereby the RBS 22 tracks the power headroom at each mobile station 12, while simultaneously reducing the signaling overhead that would arise if the mobile stations 12 simply transmitted power headroom reports to the RBS 22 at a high rate. FIG. 3 illustrates exemplary power headroom tracking at the RBS 22 with respect to a particular mobile station 12. It should be understood that RBS 22 is configured to perform like power headroom tracking for a plurality of mobile stations 12.

Processing begins with receipt of a “full” power headroom report from a mobile station 12. The full report may comprise multiple bits in a Protocol Data Unit (PDU) header that indicates the mobile station's power headroom (Step 100). For example, a five-bit indicator provides thirty-two (2ⁿ) measurement levels that may be used to indicate transmit power headroom. RBS 22 maintains a stored headroom value for the mobile station that is updated based on the power headroom indicated in the full power headroom report (Step 102). Essentially, this step resets the stored headroom value to the value indicated by the full report. Thus, the stored headroom value is reset responsive to receiving each full report.

To track changes in the mobile station's power headroom over the intervals between full reports, RBS 22 uses reverse link power control information associated with the mobile station 12 (Step 104). That is, it uses information associated with ongoing reverse link power control of the mobile station's reverse link transmit power to keep the stored headroom value current over the intervals between full reports and then resets the stored value upon receiving the next full report (Step 106).

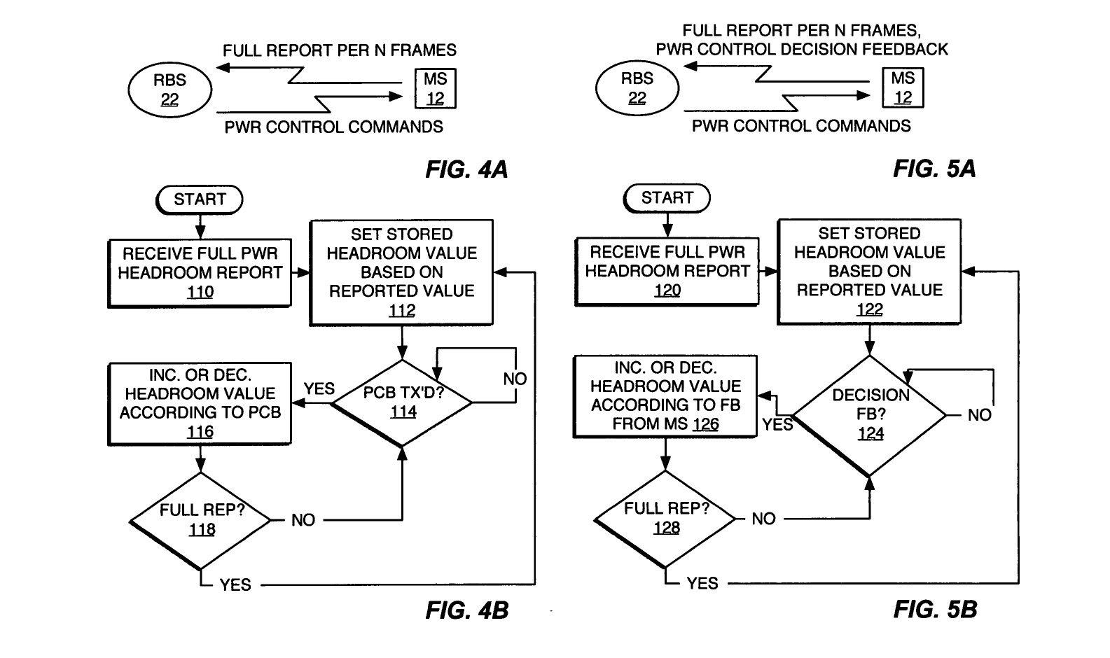

FIGS. 4A and 4B illustrate a first exemplary embodiment, wherein RBS 22 receives periodic full reports from the mobile station 12, e.g., every 20 ms. In between full reports, the RBS 22 updates the headroom value stored for the mobile station 12 such that it tracks changes in the mobile station's transmit power based on the power control commands sent to the mobile station 12 during the intervals between full reports. In an exemplary embodiment, RBS 22 is configured to incrementally adjust the stored headroom value up or down for each power control command transmitted to the mobile station 12. For example, if RBS 22 transmits an up command to the mobile station 12, it decrements the headroom value by the amount by which the mobile station 12 is assumed to have increased its transmit power responsive to receiving the up command. Conversely, if a down command is transmitted to the mobile station 12, RBS 22 increments the headroom value by the amount by which the mobile station 12 is assumed to have decreased its transmit power responsive to receiving the down command.

Thus, the illustrated processing begins with receipt of a full report at RBS 22 (Step 110), which is used to set the stored headroom value (Step 112). Then, in response to each PCB transmitted to the mobile station (Step 114), RBS 22 increments or decrements the headroom value accordingly (Step 116). Note that such decrementing and incrementing of the headroom value generally should be based on the known step size changes that mobile station 12 makes in its transmit power responsive to the RBS's power control commands. These incremental adjustments continue until receipt of the next full report (Step 118), which then resets the headroom value based on the value received in the full report.

FIGS. 5A and 5B illustrate another exemplary embodiment that may be used in conjunction with that described immediately above, such as during soft handoff conditions, or may be used as an alternative regardless of whether the mobile station 12 is in soft handoff. According to the illustrated logic, the RBS 22 tracks power headroom at mobile station 12 during the intervals between full reports based on feedback from the mobile station 12. That is, rather than assuming that its transmitted power control commands accurately represent actual transmit power adjustments at mobile station 12, RBS 22 monitors power control decisions as feedback from the mobile station.

Thus, the mobile station 12 is configured to transmit a decision indicator at each power control decision point, i.e., that indicates whether it incremented or decremented its transmit power for that control interval. With this approach, tracking accuracy may be improved because adjustments to the headroom value stored for the mobile station 12 at RBS 22 are made based on the actual power control adjustment made by the mobile station 12 rather than on the power control commands being transmitted by RBS 22, which the mobile station 12 may or may not follow. Mobile station 12 may not follow the RBS's power control commands due to reception errors at the mobile station 12, or due to soft handoff conditions, wherein the mobile station 12 receives power control commands from one or more additional RBSs 22.

Exemplary processing according to this embodiment thus comprises receiving periodic full reports from mobile station 12 as before (Step 120), and setting the power headroom value stored for the mobile station 12 based on the headroom indicated by the full report (Step 122). Then, in the intervals between full reports, RBS 22 increments or decrements the stored headroom value responsive to each power control decision feedback value received from the mobile station 12 (Steps 124 and 126). As before, the stored headroom value is reset responsive to receiving the next full report (Step 128).

Mobile station 12 may be configured to stream power control decision feedback to the RBS 22 at the same rate it receives power control commands. Thus, for example, the mobile station 12 may transmit a decision indicator for each power control interval, e.g., a single bit value, that indicates whether the mobile station 12 incremented or decremented its power for that interval. Nominally, then, the mobile station 12 transmits indicators at the same rate that it receives power control commands, e.g., 400 Hz, 800 Hz, etc. However, those skilled in the art should appreciate that it could send decision feedback at a half-rate, or other rate as needed or desired.

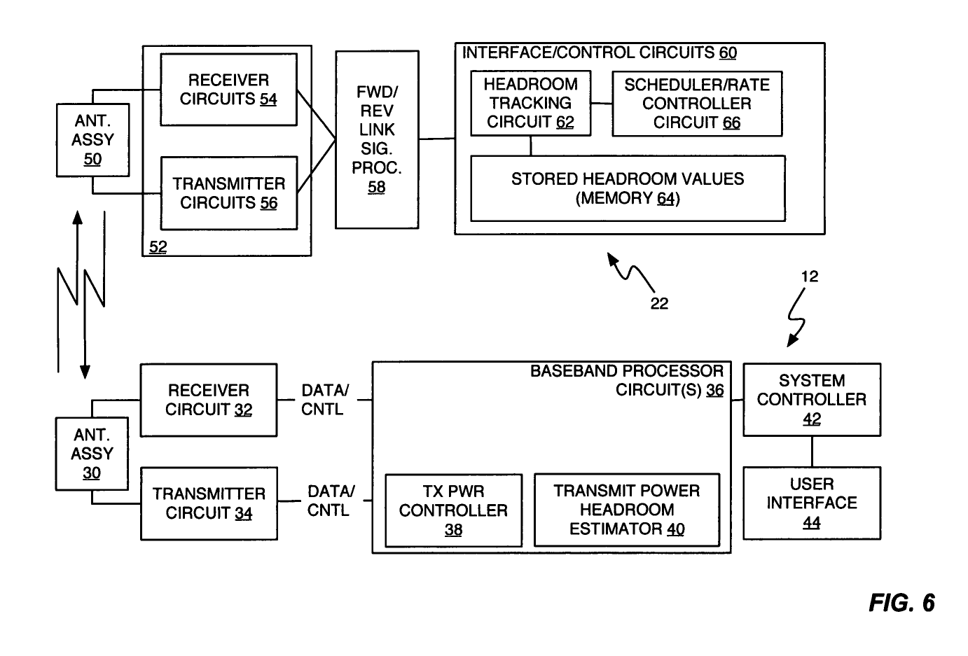

FIG. 6 illustrates exemplary mobile station and radio base station configurations that may be used to carry out the present invention in any of its exemplary embodiments. The exemplary mobile station 12 comprises an antenna assembly 30, a receiver circuit 32, a transmitter circuit 34, baseband processor circuits 36, including a transmit power controller 38 and transmit power headroom estimator 40, a system controller 42 and its associated user interface 44, i.e., display, keypad, etc. RBS 22 comprises a receive/transmit antenna assembly 50, transceiver circuits 52, including receiver circuits 54 and transmitter circuits 56, forward/reverse link signal processing circuits 58, and interface/control circuits 60, including headroom tracking circuit 62, memory 64, and scheduler/rate controller 66. Those skilled in the art should recognize that other functional arrangements for either or both the mobile station 12 and RBS 22 could be used to support the present invention.

Further, those skilled in the art should appreciate that the present invention can be embodied in hardware, software, or some combination thereof. For example, headroom tracking circuit 62 and scheduler/rate controller circuit 66 may be implemented as stored program instructions for execution on a microprocessor or other logical processing circuit included in RBS 22.

In any case, headroom tracking circuit 62 maintains a headroom value in memory 64 for each mobile station 12 being tracked. During ongoing radio service, RBS 22 receives periodic full reports from a plurality of mobile stations 12, and signal processing circuits 58 extract the reported headroom values from that received information and provide them to headroom tracking circuit 62, which uses the received information to refresh the corresponding stored headroom values. As explained above, headroom tracking circuit 62 compensates the headroom values between full reports based either on the power control commands being transmitted from the RBS 22 to the mobile stations 12, or based on power control decision feedback received from the mobile stations 12.

In either case, scheduler/rate controller circuit 66 may use the stored headroom information to improve its ongoing rate control operations. For example, scheduler/rate controller 66 may be configured to grant higher reverse link data rates to a subset of the mobile stations 12 at any given time. For example, scheduler/rate controller 66 would avoid selecting a mobile station 12 for a contemplated reverse link rate increase if it had insufficient power headroom to support the rate increase as indicated by the headroom value stored for it in memory 64.

Of course, the stored power headroom values may be used to additional advantage in RBS operations and the present invention is not limited to the exemplary usage in ongoing reverse link rate control as described above. Indeed, the present invention is not limited by the foregoing discussion but rather is limited by the following claims and their reasonable equivalents.

What is claimed is:

1. A method of tracking mobile station power headroom at a wireless communication network base station comprising:
receiving a power headroom report from a mobile station;
storing a headroom value for the mobile station based on the power headroom report received from the mobile station; and
updating the headroom value to track changes in a transmit power of the mobile station based on reverse link power control information associated with the mobile station.

2. The method of claim 1, wherein receiving a power headroom report from a mobile station comprises receiving periodic power headroom reports from the mobile station.

3. The method of claim 2, wherein storing a headroom value for the mobile station based on the power headroom report received from the mobile station comprises setting the stored headroom value to a received headroom value in each periodic power headroom report.

4. The method of claim 1, wherein updating the headroom value to track changes in a transmit power of the mobile station based on reverse link power control information associated with the mobile station comprises incrementing and decrementing the headroom value based on reverse link power control commands being transmitted to the mobile station.

5. The method of claim 4, further comprising transmitting reverse link power control commands to the mobile station at a defined rate, and wherein incrementing and decrementing the headroom value based on reverse link power control commands being transmitted to the mobile station comprises:
decrementing the headroom value responsive to transmitting an up power command to the mobile station; and
incrementing the headroom value responsive to transmitting a down power command.

6. The method of claim 1, wherein updating the headroom value to track changes in a transmit power of the mobile station based on reverse link power control information associated with the mobile station comprises receiving power adjustment feedback from the mobile station indicative of its ongoing reverse link transmit power adjustments, and updating the headroom value based on the power adjustment feedback.

7. The method of claim 6, wherein receiving power adjustment feedback from the mobile station comprises receiving power control decisions from the mobile station that indicate whether the mobile station increased or decreased its transmit power in a given power control interval.

8. The method of claim 1, further comprising determining whether to grant an increased reverse link data rate to the mobile station based on the headroom value.

9. The method of claim 1, further comprising determining whether to select the mobile station for a reverse link rate adjustment based on the headroom value.

10. The method of claim 1, wherein the mobile station comprises one in a plurality of mobile stations being supported by the base station, and further comprising receiving power headroom reports from the plurality of mobile stations, storing headroom values for the plurality of mobile stations, and updating the headroom value for each mobile station based on reverse link power control information associated with each mobile station.

11. A method of tracking mobile station power headroom at a wireless communication network base station comprising:
periodically receiving a full report from a mobile station that indicates a transmit power headroom of the mobile station;
updating a headroom value maintained at the base station for the mobile station responsive to receiving each full report; and
tracking changes in transmit power headroom between each full report using reverse link power control information associated with the mobile station.

12. The method of claim 11, wherein periodically receiving a full report from a mobile station that indicates a transmit power headroom of the mobile station comprises periodically receiving one or more bits in a Packet Data Unit (PDU) header.

13. The method of claim 12, wherein periodically receiving a full report from a mobile station that indicates a transmit power headroom of the mobile station comprises receiving a full report from the mobile station every N reverse link transmit frames, where N is an integer number greater than zero.

14. The method of claim 11, wherein tracking changes in transmit power headroom between each full report using reverse link power control information associated with the mobile station comprises receiving one or more differential reports from the mobile station during intervals between the full reports.

15. The method of claim 11, wherein tracking changes in transmit power headroom between each full report using reverse link power control information associated with the mobile station comprises receiving one or more bits at each reverse link power control decision point indicating whether the mobile station incrementally increased or decreased its reverse link transmit power at that decision point.

16. The method of claim 15, wherein tracking changes in transmit power headroom between each full report using reverse link power control information associated with the mobile station further comprises incrementally adjusting the headroom value up or down according to the differential reports being received from the mobile station.

17. The method of claim 11, further comprising determining whether to select the mobile station for a reverse link rate increase based on whether the headroom value maintained at the base station for the mobile station indicates that the mobile station has sufficient transmit power headroom to support a contemplated higher rate.

18. The method of claim 11, wherein tracking changes in transmit power headroom between each full report using reverse link power control information associated with the mobile station comprising incrementally adjusting the headroom value for the mobile station based on reverse link power control commands being transmitted to the mobile station.

19. The method of claim 11, wherein tracking changes in transmit power headroom between each full report using reverse link power control information associated with the mobile station comprises receiving one or more differential reports from the mobile station between the full reports, wherein the differential reports indicate incremental adjustments in transmit power being made by the mobile station responsive to reverse link power control commands received by the mobile station.

20. The method of claim 19, wherein the mobile station comprises one in a plurality of mobile stations, and further comprising maintaining headroom values for the plurality of mobile stations responsive to receiving full and differential reports from each mobile station.

21. The method of claim 20, further comprising using the headroom values maintained for the plurality of mobile stations to determine whether particular ones of the mobile stations are candidates for reverse link rate increases.

22. A base station for use in a wireless communication network comprising:
transceiver circuits to communicate with a plurality of mobile stations via wireless signaling; and
one or more processing circuits to control communications with the plurality of mobile stations;
said one or more processing circuits including a headroom tracking circuit configured to track transmit power headroom for a mobile station by:
periodically receiving a full report from the mobile station that indicates a transmit power headroom of the mobile station;
updating a headroom value maintained at the base station for the mobile station responsive to receiving each full report; and
tracking changes in transmit power headroom between each full report using reverse link power control information associated with the mobile station.

23. The base station of claim 22, wherein the headroom tracking circuit is configured to periodically receive one or more bits in a Packet Data Unit (PDU) header as the full report.

24. The base station of claim 23, wherein the headroom tracking circuit is configured to receive a full report from the mobile station every N reverse link transmit frames, where N is an integer number greater than zero.

25. The base station of claim 22, wherein the headroom tracking circuit is configured to track changes in transmit power headroom between each full report using reverse link power control information associated with the mobile station by receiving one or more differential reports from the mobile station during intervals between the full reports.

26. The base station of claim 22, wherein the headroom tracking circuit is configured to track changes in transmit power headroom between each full report using reverse link power control information associated with the mobile station by receiving one or more bits at each reverse link power control decision point indicating whether the mobile station incrementally increased or decreased its reverse link transmit power at that decision point.

27. The base station of claim 26, wherein the headroom tracking circuit is configured to track changes in transmit power headroom between each full report using reverse link power control information associated with the mobile station further by incrementally adjusting the headroom value up or down according to the differential reports being received from the mobile station.

28. The base station of claim 22, wherein the base station is configured to determine whether to select the mobile station for a reverse link rate increase based on whether the headroom value maintained for the mobile station indicates that the mobile station has sufficient transmit power headroom to support a contemplated higher rate.

29. The base station of claim 22, wherein the headroom tracking circuit tracks changes in transmit power headroom between each full report using reverse link power control information associated with the mobile station by incrementally adjusting the headroom value for the mobile station based on reverse link power control commands transmitted to the mobile station.

30. The base station of claim 22, wherein the headroom tracking circuit tracks changes in transmit power headroom between each full report using reverse link power control information associated with the mobile station by receiving one or more differential reports from the mobile station between the full reports, wherein the differential reports indicate incremental adjustments in transmit power being made by the mobile station responsive to reverse link power control commands received by the mobile station.

31. The base station of claim 30, wherein the headroom tracking circuit is configured to maintain headroom values for the plurality of mobile stations responsive to receiving full and differential reports from each mobile station.

32. The base station of claim 31, wherein the base station is configured to use the headroom values maintained for the plurality of mobile stations to determine whether particular ones of the mobile stations are candidates for reverse link rate increases.
